(19) United States
(12) Patent Application Publication
(10) Pub. No.: US 2003/0084459 A1
(43) Pub. Date: May 1, 2003

(54) Method and apparatus for modifying a media database with broadcast media

(76) Inventors: Mark J. Buxton, Chandler, AZ (US); Alex A. Lopez-Estrada, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/017,774

(22) Filed: Oct. 30, 2001

(51) Int. Cl. H04N 7/16

(52) U.S. Cl. 725/135; 725/142; 725/151

(57) ABSTRACT

A method and apparatus for modifying a media database with broadcast media. A receiver receives a broadcast signal from a broadcast source. A selector selects a segment of the broadcast signal. An identifier determines if the selected broadcast segment contains valid signal content in relation to a plurality of signals, which are stored in a signal database. A modifier modifies the signal database with a portion of the selected segment if the segment is identified as having valid signal content.

### FIELD OF THE INVENTION

This invention relates generally to a database that includes broadcast media. More particularly, this invention relates to a method and apparatus for modifying a media database with broadcast media.

### BACKGROUND OF THE INVENTION

Broadcast media serves a variety of purposes and has become a dominant source of news and entertainment. Radio and television broadcasts already provide a rich source of information. With the recent emergence of broadband communications and digital broadcast technology, the Internet and other new broadcast sources provide a tremendous variety of information, which is easily accessible.

A large amount of the broadcast media available is free to the public, such as television, radio and Internet media. Other broadcast information is available for a fee, such as copywrited audio file downloads from the Internet and sporting events viewed on cable television with a special viewing fee.

A scheme to maintain and update a media database that includes broadcast media allows users to take full advantage of media offerings by storing received media in an organized fashion. It is advantageous for the scheme to be capable of modifying the media database with both free and for fee media, and updating the database as new media becomes available.

Personal computers and multi-media set-top boxes already have the storage and processing capabilities to maintain and modify a media database with broadcast media. A standard radio receiver can easily be connected to a personal computer (PC) through the audio input ports of a typical sound card. Television signals can also be input to PCs with video cards. Set-top boxes, which are capable of receiving cable radio broadcasts, already include components for receiving both video and audio media. Therefore, a scheme to modify a media database may be implemented on systems that are readily available, with little or no additional cost.

### BRIEF DESCRIPTION OF THE DRAWINGS

FIG. 1 is a system overview for one embodiment of the invention.

FIG. 2A graphically illustrates a continuous radio broadcast signal and a radio signal segment.

FIG. 2B illustrates an example of a radio signal segment.

FIG. 3 illustrates one embodiment of a system for practicing the invention.

FIG. 4 is a flow chart overview for one embodiment of the present invention.

FIG. 5 is a detailed flow chart of one embodiment for modifying a media database.

FIG. 6 describes one embodiment for computing a likeness coefficient.

FIG. 7 illustrates one embodiment of a system for modifying a song database with a radio broadcast signal.

### DETAILED DESCRIPTION OF THE INVENTION

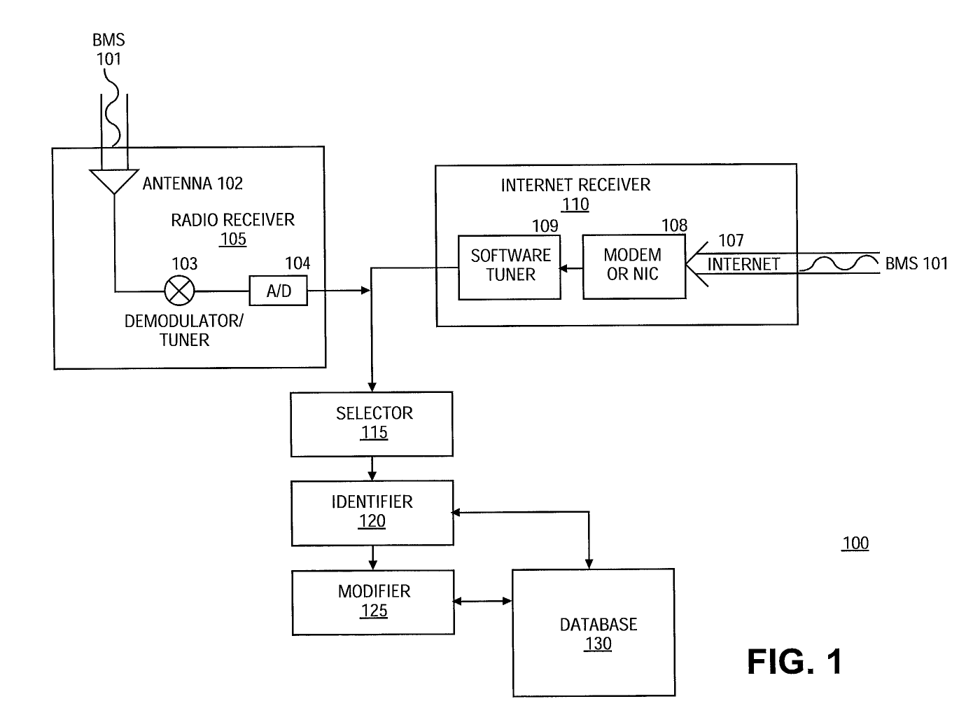

FIG. 1 shows a system 100 for one embodiment of the present invention. The system in FIG. 1 includes devices that receive a broadcast media signal (BMS) 101, select a segment of the BMS 101, identify the contents of the segment, and modify a media database, if appropriate. A receiver device receives a BMS 101 from one or more broadcast sources.

In the example system 100, two separate receiver devices are shown. A radio receiver 105 and an Internet receiver 110 provide the reception of a BMS 101. Either or both devices 105 and 110, along with other receiver devices, may operate as part of system 100, individually or simultaneously. The radio receiver 105 comprises an antenna 102, a demodulator/tuner 103, and an analog to digital (A/D) converter 104. The Internet receiver 110 comprises an Internet connection 107, a modem or network interface card (NIC) 108, and a software tuner 109. Once the BMS 101 is received by a receiver device, a selector 115, coupled to the receivers 105 and 110, selects a segment of the BMS 101. The selector 115 selects the appropriate amount of the BMS 101 to be processed based on system processing capabilities that will vary from system to system. An identifier 120 coupled to the selector 115, identifies the signal by analyzing signal characteristics of the BMS 101 segment. A modifier 125, coupled to the identifier 120, changes the contents of a media database 130 if the identified signal will enhance the media database 130. The media database 130, is coupled to both the identifier 120 and the modifier 125. In one embodiment, the modifier 125 enhances the media database 130 by adding BMS 101 information to the media database 130 that may not yet be in the media database 130. In another embodiment, the modifier 125 enhances the media database 130 by increasing the quality of media that already exists in the media database 130.

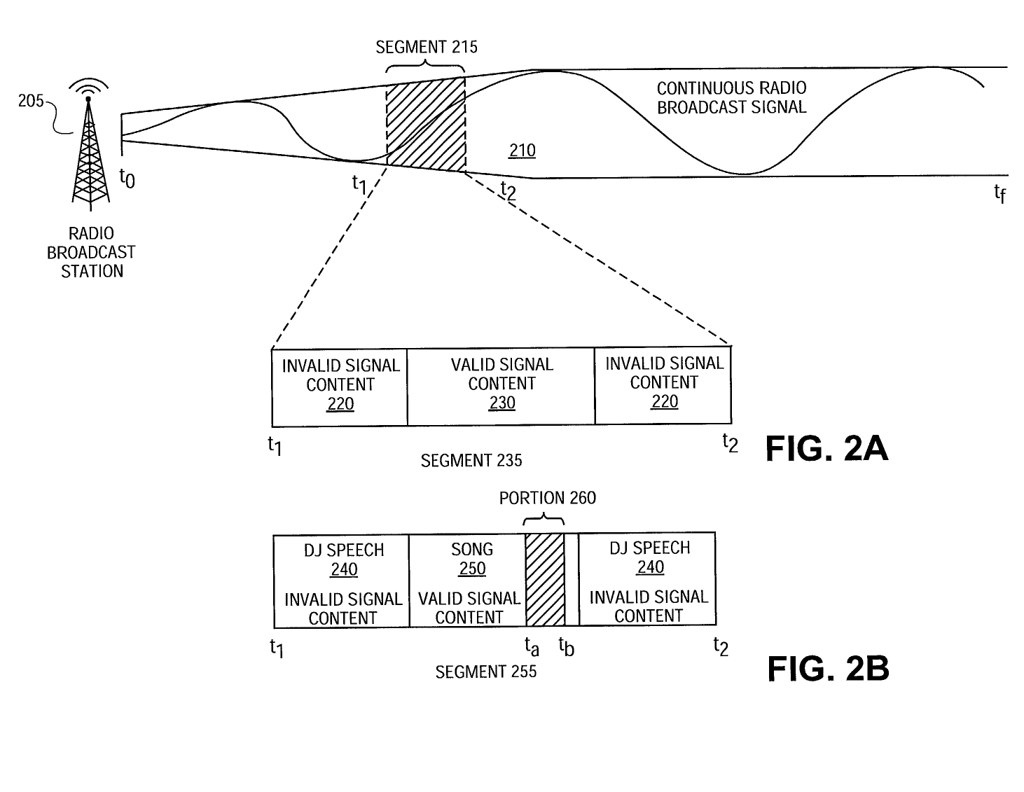

FIG. 2A graphically illustrates a continuous radio broadcast signal and a radio signal segment. A radio broadcast station 205 transmits a continuous radio broadcast signal 210 from time t₀ to time t_{f}. A segment 215, shown in the shaded region of FIG. 2A, may be a discrete part of the continuous radio signal 210. The example segment 215 starts at time t₁ ends at time t₂, and has duration of t₂-t₁ seconds. A generic example of a segment, where the segment includes valid signal content 230 and invalid signal content 220, is shown in a segment 235. The segment 235 is an expanded view of the segment 215 from time t₁ to t₂. Valid signal content 230 is content that may be used to enhance a media database, whereas invalid signal content 220 may be content that is not typically used to enhance a media database.

FIG. 2B shows an example of a radio broadcast signal segment 255. The segment 255 includes disk jockey (DJ) speech 240, followed by a song 250, followed by DJ speech 240. If the segment 255 is used in a system to modify a song database, then the song 250 may be valid signal content and the DJ speech 240 may be invalid signal content. Another important concept is a portion 260, which is shown as the shaded region from time tₐ to t_{b} in FIG. 2B. Although the portion 260 is shown in FIG. 2B as a small part of the segment 255, a portion may encompass an entire segment. A portion may include any combination of valid and invalid signal content.

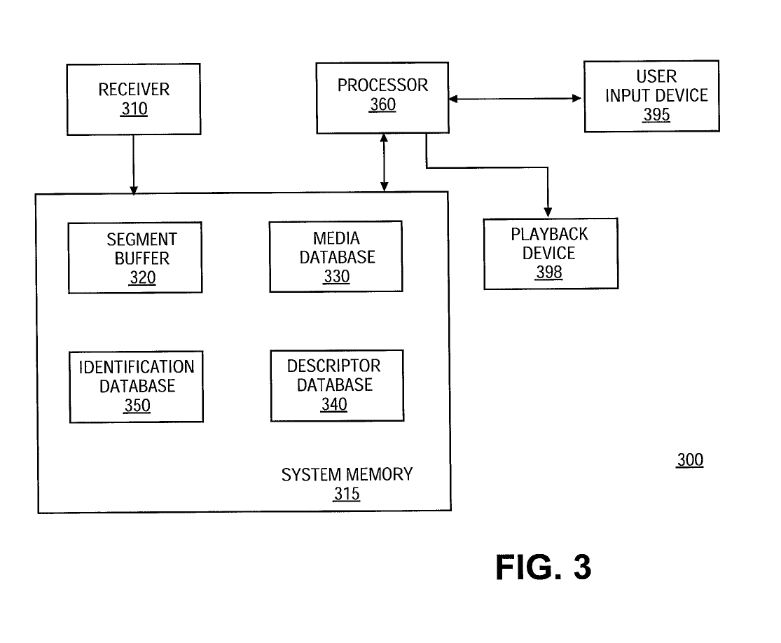

FIG. 3 is a system block diagram 300 of an embodiment for the practice of the present invention. A receiver 310 receives a broadcast media signal from a broadcast source. In one embodiment the BMS may be a radio signal. In another embodiment, the BMS may be a television signal. In yet another embodiment, the BMS may be an Internet signal. It should be appreciated by one skilled in the art, that the receiver 310 may receive many different types of analog and digital BMS signals, from one of many different types of broadcast sources. For example, the receiver 310 may receive a BMS from a frequency modulation (FM) radio station or other wireless broadcast sources. The receiver 310 may receive a BMS from a network broadcast source broadcasting over fiber optic or twisted pair copper wire. In one embodiment the receiver 310 receives a BMS from a single broadcast source. In another embodiment the receiver 310 receives multiple BMS's from multiple broadcast sources.

Once a BMS is received, a segment of the BMS may be selected and stored in a segment buffer 320. The duration of the segment stored in the segment buffer 320 depends on the processing capabilities of the system processor 360 and the processing load of the system. If the processor is dedicated to performing the tasks of the present invention then the segment buffer may be relatively small and the BMS segment may be processed in real-time. If the system of the present invention is part of a standard PC, which is being simultaneously used for multiple tasks, then the segment buffer may be relatively large because the processor may be required to perform tasks outside of the present invention. In one embodiment, the segment buffer resides in system memory 315. In another embodiment the segment buffer may be stored in a dedicated memory device.

If the BMS segment contains valid signal content, the valid content may be used to update a media database 330. The media database 330 may be a database of stored media signals. In one embodiment, the signals stored in the media database 330 may be songs. In another embodiment the signals stored in the media database 330 may be videos. It should be apparent to one skilled in the art that there are many types of media signals that can be stored in a media database.

In one embodiment, a part of the media database 330 may be loaded directly into memory from a compact disk (CD). In another embodiment, media may be downloaded directly from a network connection. Therefore, the media database 330 of the present invention may include media that may be stored directly into the media database 330 from non-broadcast sources in addition to media that may be received from a broadcast source. In one embodiment, the media database 330 may be stored in system memory 315. In another embodiment, the media database 330 may be stored in a dedicated memory device. In yet another embodiment, the media database 330 may be stored external to the system on a network accessible by the system 300.

For each signal stored in the media database 330, there may be a corresponding signal descriptor. Descriptors may be stored in a descriptor database 340. A descriptor includes information extracted from a media signal and provides a relatively unique description of the media signal used for accurate comparison with other signal descriptors. A descriptor may be more compact than the original media signal. Therefore, comparisons between descriptors may be more efficient than comparisons between media signals. In one embodiment, the descriptor may be a portion of the media signal. In another embodiment, the descriptor may contain information relating to a media signal characteristic. In yet another embodiment, a descriptor may contain information relating to multiple media signal characteristics. An example of a signal characteristic is the amplitude of the signal. Another example of a signal characteristic is the frequency content of a signal. A descriptor may contain information relating to signal characteristics at a specific time interval. For example, the descriptor may include the amplitude of the signal every 1/100th of a second. For another example, the descriptor may include the frequency content of the signal at the time when the signal has its highest ten amplitude peaks. In one embodiment, the descriptor database 340 may be stored in system memory 315. In another embodiment, the descriptor database 340 may be stored in a dedicated memory device. In yet another embodiment, the descriptor database 340 may be stored on a network accessible by the system 300.

For each signal in the media database 330 and corresponding descriptor in the descriptor database 340, there may be identification information in an identification database 350. Identification information describes the content of the corresponding signal in the media database 330. In one embodiment, the identification information includes the title and author information. In another embodiment, the identification information includes the duration of the media signal. It should be understood that there may be many embodiments of identification information. In one embodiment, the identification database 350 may be stored in system memory 315. In another embodiment, the identification database 350 may be stored on a network accessible by the system 300. In yet another embodiment, the identification database 350 may be stored in a dedicated memory device. It should be apparent to one skilled in the art, that the media, descriptor, and identification databases may be stored together or separately in various combinations.

The system processor 360 may be used to process the BMS in the segment buffer and make modifications to the media database 330, descriptor database 340, and identification database 350. In one embodiment, the processor may be used for generating descriptors for the BMS in the segment buffer and for making comparisons with the descriptor database 340. In another embodiment, the processor may be used for accessing signals in the media database 330, based on the information such as title and genre from the identification database 350, controlled through a user input device 395.

The user input device 395 allows a user to select a media signal from the media database and play it back through the playback device 398. In one embodiment, the playback device 398 may be an audio speaker. In another embodiment, the playback device 398 may be a video screen. In one embodiment, the user input device 395 allows the user to access the media signals in the media database by selecting an element of the identification database 350. For example, if the identification database 350 includes title, artist, and genre information corresponding to the songs in a song database, then a user can access a song by its title, artist, or genre. The user then has the capability to set up cross-referenced song playlists. In one embodiment the user interface device 395 may be a keypad which allows the user to input commands to the system. In another embodiment the user interface device 395 may be a graphical user interface.

Media signals, descriptors, and identification information may come from a variety of sources. For example, if the media database contains songs, the songs may be loaded from a CD, an audio file that has been downloaded from the Internet, and a BMS that has been processed with the present invention. Descriptors and identification information may also be downloaded from the Internet or loaded onto the system from sources such as a CD, floppy disk, and user input. It is also within the scope of the present invention to receive descriptors and/or identification information from a broadcast media source. In one embodiment, descriptors and identification information may be embedded in the BMS and the system extracts the information from the broadcast. In another embodiment, descriptors and identification information may be broadcast on a special broadcast channel to the receiver. In yet another embodiment, descriptors and identification information precede or follow the broadcast of the corresponding BMS.

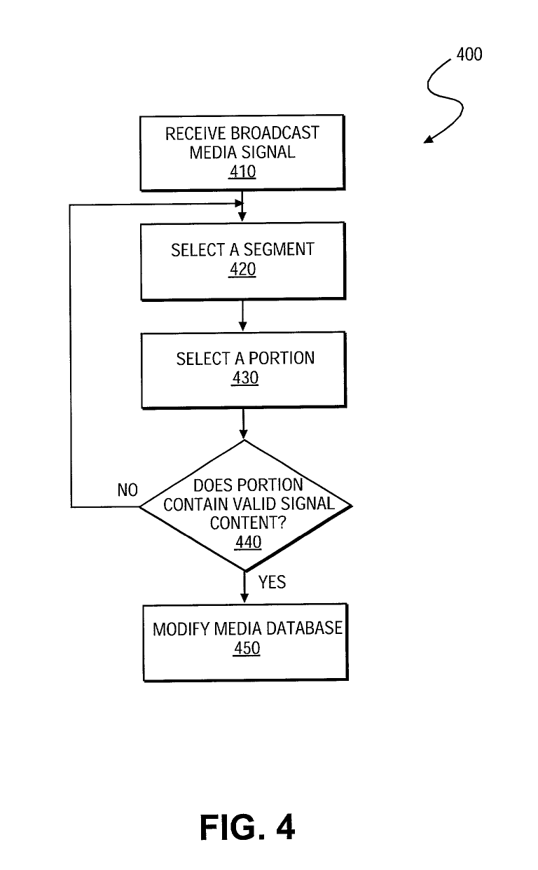

FIG. 4 shows a flow chart overview 400 for one embodiment of the present invention. First, a BMS is received 410 from a broadcast source. Next, the flow proceeds to select a segment 420. As was previously discussed, the duration of the segment selected may be based on system processing capabilities. In one embodiment, the selected segment includes 10 minutes worth of a BMS. Popular songs broadcasted on the radio are typically under five minutes in duration. Selecting a segment that is twice the duration of a typical song will have a relatively high probability of including a whole song.

In one embodiment, selecting a segment 420 includes analyzing the BMS characteristics for valid signal content. Two characteristics that may be analyzed are signal amplitude level and signal frequency content. In the case of a song database, where songs are valid signal content and all other content is invalid, advertisements are typically broadcasted at a higher amplitude than songs. The system may refrain from selecting a segment for processing unless the received signal amplitude is below a predetermined threshold. DJ speech typically has frequency content in the range of 250 to 6,000 Hertz (Hz). Music has a frequency range of 40 to 20,000 Hz. The system may refrain from selecting a segment unless the received signal has frequency content outside the speech range. Therefore, in one embodiment, selecting a segment results in a segment that contains only valid signal content. In another embodiment, selecting a segment results in a segment that contains both valid and invalid signal content, as shown in FIG. 2B. It may also be possible that selecting a segment results in a segment with only invalid signal content. It should be apparent to one skilled in the art that there may be many signal characteristics and analytical signal processing methods, such as Fourier and wavelet transform analysis, that may be used to analyze a signal and select a segment.

Once a segment is selected, the flow proceeds to select a portion 430. In one embodiment, the selected portion may be the whole segment. In another embodiment, the portion selected may be of a shorter duration than the segment. The selected portion may contain any combination of valid and invalid content. In one embodiment, the duration, start point, and end point of the portion may be selected based on signal characteristics as previously described. In an alternate embodiment, there may be no portion selected. For example, if the segment is selected based on signal characteristics, contains only valid signal content, and is the appropriate duration for further processing, then there is no need to select a portion. In this alternate embodiment, any operations that are described as being performed on the portion are performed on the segment.

After selecting a portion of the segment, a determination is made to see if the selected portion contains valid signal content 440. In one embodiment, the determination may be based on measured signal characteristics such as amplitude and frequency content, as previously described. If the segment portion contains valid content that enhances the media database, then the media database is modified 450. In one embodiment, if there is not valid signal content in the portion, a new segment is selected 420. In another embodiment, if there is not valid signal content in the portion, another portion of the segment is selected 430. In another embodiment, the selection of a segment portion 430 and the determination if the portion contains valid signal content 440 are combined to select a portion of the signal that contains only valid signal content. In yet another embodiment, the selection of a segment 420 and the determination if there is valid content 440 are combined to select a segment that only contains valid signal content. It should be apparent to one skilled in the art that the selecting of segments, selecting of portions, and determining if there is valid signal content can be combined in various ways.

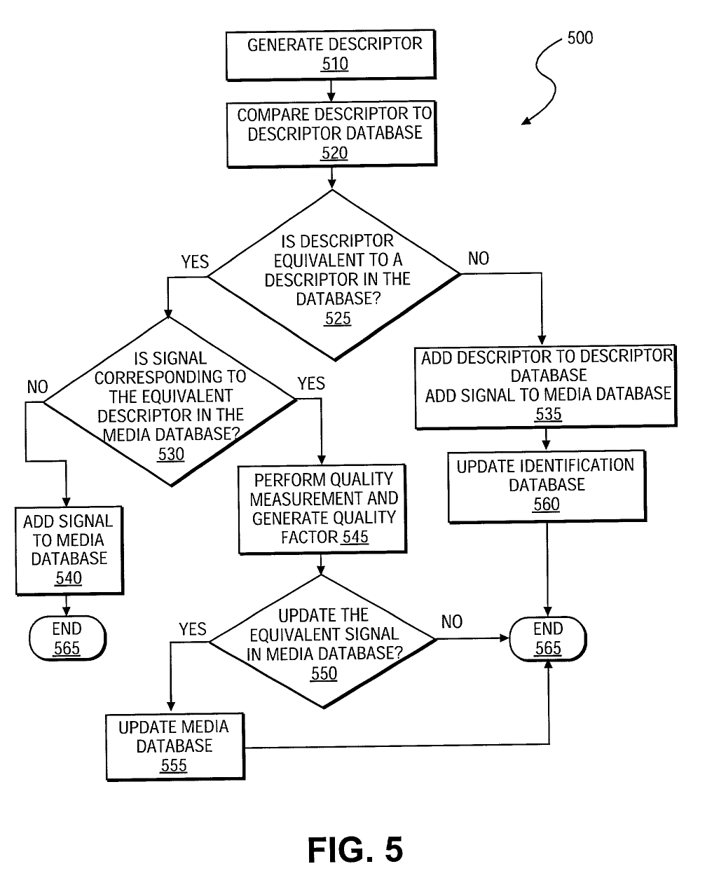

FIG. 5 shows a detailed flow chart 500 of one embodiment for modifying a media database. A descriptor is generated 510 for a selected portion. In one embodiment, generating a descriptor may be selecting a portion of the BMS as the descriptor. In another embodiment, generating a descriptor may be measuring a signal characteristic of the selected portion and using characteristic information as a descriptor. In yet another embodiment, a descriptor may contain information relating to multiple signal characteristics. Examples of signal characteristics are amplitude levels, frequency content, signal-to-noise ratio (SNR), and occurrence information.

Occurrence information is the relation between an event and the time when it occurs, as well as the duration of an event. One example of occurrence information may be the total amount of time a portion has amplitude above a predetermined threshold. Another example of occurrence information may be the time interval between two occurrences of similar frequency content in a portion. A popular song typically has different frequency content during the verse and the chorus of the song. The duration of a chorus, which may be determined with widely known frequency content analysis techniques, is occurrence information. There are many combinations of portions and signal characteristics that may be used as a descriptor.

After a descriptor is generated, the descriptor is compared to a descriptor database 520. In one embodiment, the generated descriptor may be compared to all descriptors in the descriptor database. Depending on the number of descriptors in the descriptor database and the comparison method, comparing the generated descriptor to every descriptor in the database may be inefficient. In another embodiment, the generated descriptor may be compared to a limited number of descriptors in the descriptor database. In one embodiment, comparing two descriptors consists of computing an equivalence value. An equivalence value is a measure of likeness between descriptors. In one embodiment, equivalence may be based on a correlation coefficient. In another embodiment, equivalence may be based on a likeness coefficient, which will be subsequently described.

Next, a determination is made on whether or not the generated descriptor is equivalent to a descriptor in the descriptor database 525. In one embodiment, this determination may be based on a predefined threshold for equivalence. For example, if the likeness coefficient for a descriptor and an element of the descriptor database is below a predefined threshold, then the generated descriptor and the database descriptor are equivalent. If it is determined that the coefficient is above a predefined threshold, then the descriptor and the element of the descriptor database are not equivalent.

In an alternate embodiment, comparing the descriptor to the descriptor database 520 and the determining if the descriptor is equivalent to a descriptor in the database 525 may be combined. In this embodiment, the comparison includes comparing the generated descriptor to a limited number of descriptors that are representative of specific groups of descriptors in the descriptor database, selecting the group corresponding to the representative that has the highest equivalence with the generated descriptor, and comparing the generated descriptor with every descriptor in the selected group. The advantage of this embodiment is that the number of comparisons required to identify the most equivalent descriptor is greatly reduced.

If no equivalent descriptor is found in the database, the generated descriptor is added to the descriptor database and the portion is added to the media database 535. In another embodiment, the portion and the descriptor may be discarded if there is no equivalence. Following the storing of the portion and corresponding descriptor in their respective databases, the identification database is updated 560 with information corresponding to the new descriptor and stored portion. After updating the identification database, the processing of the portion ends 565.

If the generated descriptor is equivalent to a descriptor in the descriptor database, a determination is made to see if a media signal corresponding to the equivalent descriptor is in the media database 530. As was previously mentioned, descriptors can be loaded from various sources. In one embodiment, the descriptor database may be updated before the media database is updated. For example, a song descriptor database and corresponding identification information database may be updated periodically with new release information. Subsequently, a song database may be updated with the newly released songs using the present invention as they are broadcast from a radio station. If the corresponding media signal is not already in the media database, media signal from the segment is added to the media database 540 and processing of the portion ends 565.

In one embodiment, the media signal added to the media database may not be limited to the portion that was used to generate a descriptor 510. For example, if a two minute song is identified by generating a descriptor from the first 27 seconds of music and finding an equivalent descriptor in the descriptor database, then the whole song, not just the first 27 seconds, may be added to the song database.

If the media signal corresponding to the equivalent descriptor is in the media database, then a quality measurement is performed and a quality factor is generated 545. In one embodiment, the quality measurement includes estimating the SNR of the signal, and selecting the SNR as the quality factor. In another embodiment, performing the quality measurement includes determining if the media signal contains information that may be absent from the equivalent media signal in the media database, and the quality factor may be the duration of the valid content of the media signal in the segment.

After the quality measurement is performed and a quality factor is generated, a determination is made on whether or not to update the equivalent media signal 550 that is already in the media database. In one embodiment, the determination of whether or not to update the media database 550 involves comparing the quality factor of the media signal in the segment to the quality factor of the equivalent media signal in the media database. In another embodiment, the determination on whether or not to update the equivalent media signal in the media database 550 may be based on determining if there is valid signal information in the segment that does not exist in the equivalent media signal. In one embodiment, if the quality factor of the media signal in the segment is in the same predetermined range as the quality factor of the equivalent media signal, then the database is updated 555 with an averaged signal. In another embodiment, if the quality factor of the media signal in the segment, such as SNR, is much lower than that of the equivalent media signal in the media database, then the media database is not updated. If the media database is not updated, processing of the portion ends 565. Otherwise, the media database is updated 555 with media signal from the segment and processing ends 565.

In one embodiment, the update of the media database 555 includes the averaging of the equivalent media signal in the media database with media signal from the segment, resulting in an averaged signal. After performing the average, the media signal in the database may be replaced with the averaged signal. It is widely known that averaging a broadcast signal over time may be an effective way to remove noise that was added during the broadcast, as long as the noise has zero mean and a Gaussian distribution over time. For example, a song received from a radio broadcast is actually the song transmitted plus noise that has been unavoidably added during the broadcast. If a song has been received a number of times, the song quality, in terms of SNR, may be increased by averaging each occurrence of the song.

In another embodiment, the update of the media database 555 includes the replacing of the media signal in the media database with media signal information from the segment. For example, a song stored in a song database may be of low quality because it was received during a thunderstorm that interfered with the broadcast. If a subsequent reception of the same song is of higher quality, it may replace the low quality song in the database.

In yet another embodiment of updating the media database 555, signal information from the segment may be concatenated to the beginning and/or end of the equivalent media signal in the media database. Radio stations typically cut off the beginning and end of a broadcasted song. A song received a second time may contain music that was cut off when the song was first received and stored in a song database. Adding the missing part of the song improves the quality of the song database. It is also within the scope of the present invention to combine the previously described embodiments for updating the media signal. For example, part of the media signal may be averaged, part of the media signal may be concatenated, and part of the media signal may be replaced when updating the media database 555.

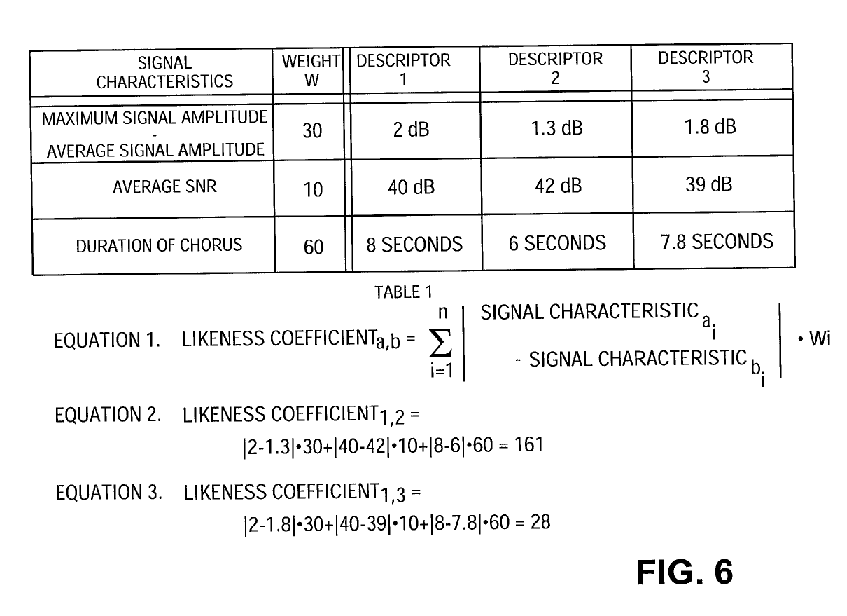

As was previously mentioned, one embodiment of comparing a descriptor to the descriptor database 520 and computing an equivalence value is computing a likeness coefficient. The computing of a likeness coefficient is described in FIG. 6. The data used to compute one embodiment of a likeness coefficient for music media is shown in Table 1. The first column of the Table 1 lists three signal characteristics for a song portion: maximum signal amplitude minus average signal amplitude, average SNR, and duration of chorus. Methods for measuring signal amplitudes and SNR for an audio signal are widely known. Assuming that the frequency content of a song's verse and chorus are distinct, the duration of chorus may be measured by identifying the points in time when the frequency content significantly changes, using widely known spectrum analysis techniques. The second column of Table 1 lists weighting factors, w, that correspond to each signal characteristic. The remaining three columns list the signal characteristic values for three descriptors, descriptors 1-3. Note that the amplitude and SNR values are in terms of decibels (dB) and the duration of chorus, which is occurrence information, is in seconds.

Equation 1 is a general equation for computing a likeness coefficient for two descriptors, a and b. The likeness coefficient is the summation from i=1 to n, where n is the number of signal characteristics, of the absolute value of the difference between the i^{th} signal characteristic of descriptor a and the i^{th} signal characteristic of descriptor b, multiplied by the i^{th} weighting factor. Equation 2 shows the likeness coefficient for descriptors 1 and 2, which is 160, and Equation 3 shows the likeness coefficient for descriptors 1 and 3, which is 28. In this embodiment, the smaller the likeness coefficient is, the more equivalent the two descriptors are. Therefore, descriptor 1 is more equivalent to descriptor 3 than it is to descriptor 2. If a predetermined likeness coefficient of 50 is used to determine equivalence, then descriptors 1 and 3 are equivalent, and descriptors 1 and 2 are not equivalent. Note that the likeness coefficient for two identical descriptors is 0. It should be appreciated by one skilled in the art that there are many different sets of signal characteristics and weighting factors that can be used to compute a likeness coefficient.

Another embodiment of descriptor comparison includes correlating descriptors. Correlation is a widely known statistical method, which results in a correlation coefficient. The correlation coefficient, r, is a measure of similarity between two variables, or in this case, two descriptors. The correlation coefficient between two descriptors, x and y, is given by Equation 4. In one embodiment, a descriptor is a series of n descriptor data points, referred to as samples. The values \overline{x} and \overline{y} are the mean values of the descriptors x and y respectively. The subscript i represents the i^{th} sample in the series of n descriptor samples. Equation 5 shows how the mean value \overline{x} for a descriptor x is calculated.

$$\begin{matrix}r = \frac{{\sum }_{i = 1}^{n} ( {x}_{i} - \overline{x} ) \cdot ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}} & \text{(Equation 4)} \\ \overline{x} = \frac{1}{n} {\sum }_{i = 1}^{n} {x}_{i} & \text{(Equation 5)}\end{matrix}$$

An advantage of using a correlation coefficient may be that it removes any linear bias between a descriptor for the selected segment and the descriptors in the database that may be caused by volume differences or time offsets.

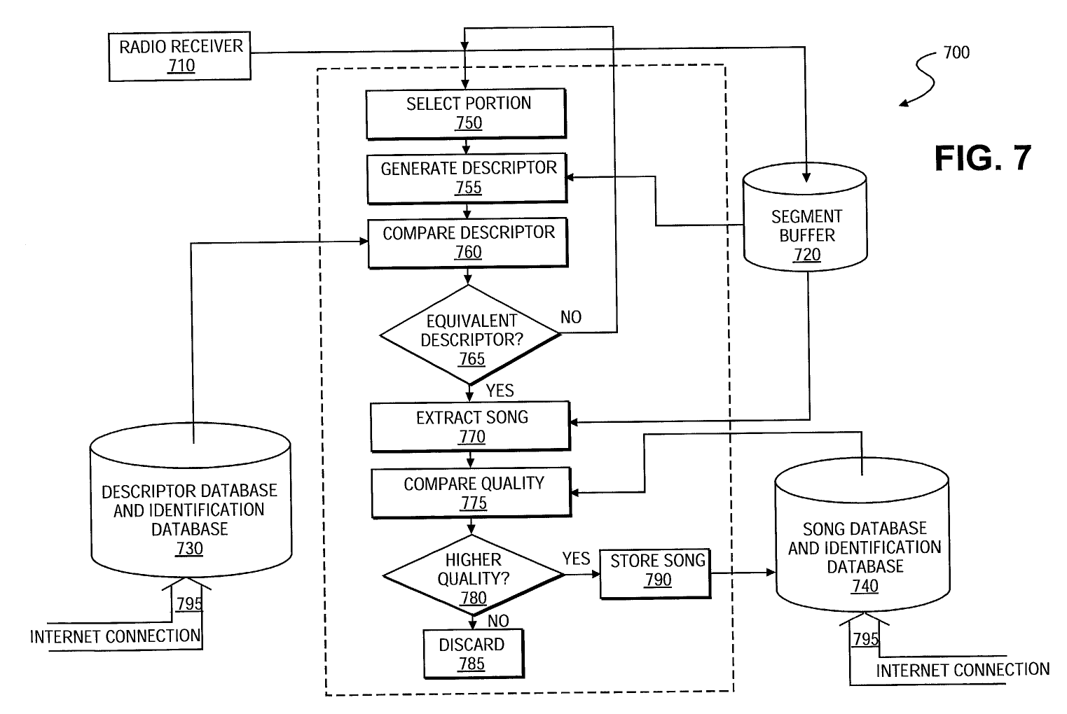

FIG. 7 illustrates one embodiment of a system 700 for modifying a song database with a radio broadcast signal. A radio receiver 710 receives a radio broadcast signal from a radio station. The radio signal is stored in a segment buffer 720 and a portion of the radio signal is selected 750. A descriptor is generated 755 from the portion selected. Next, a descriptor compare is performed 760 between the generated descriptor and descriptors stored in a descriptor database 730.

A decision is made on whether or not there is an equivalent descriptor 765 in the descriptor database 730. If there is no equivalent descriptor in the descriptor database 730, a new portion is selected 750. If an equivalent descriptor is found in the descriptor database 730, the corresponding song is extracted 770 from the segment buffer 720. Once the song is extracted, the quality of the extracted song and the quality of the equivalent song in a song database 740 are compared 775. A decision is made on which of the two songs has higher quality 780. If the extracted song has higher quality, the song is stored 790 in the song database 740. If the extracted song does not have higher quality, it is discarded 785. In this embodiment both the descriptor database 730 and the song database 740 include the information database. The descriptor, media, and identification information databases may be updated via the Internet connection 795.

In one embodiment, the methods of FIG. 4. and FIG. 5 as discussed above, may be implemented as a series of software routines run by the system of FIG. 3. In one embodiment, these software routines may comprise a plurality or series of instructions to be executed by a processor in a hardware system, such as processor 160 of FIG. 3. Initially, the series of instructions may be stored on a storage device, such as system memory 115. It is to be appreciated that the series of instructions may be machine executable instructions stored using any machine readable storage medium, such as a diskette, CD-ROM, magnetic tape, digital video or versatile disk (DVD), laser disk, ROM, flash memory, etc. It is also to be appreciated that the series of instructions need not be stored locally, and may be received from a remote storage device, such as a server on a network, a CD ROM device, a floppy disk, etc.

In alternate embodiments, the present invention may be implemented in discrete hardware or firmware. For example, one or more application specific integrated circuits (ASICs) could be programmed with the previously described functions of the present invention. In another example, the selector 15, identifier 20 and modifier 25 may be implemented in one or more ASICs. In one embodiment, the system of FIG. 3 includes an ASIC for generating descriptors 510. In another embodiment, the system of FIG. 3 includes an ASIC for modifying the media database 450. In yet another embodiment, the system of FIG. 3 includes a receiver ASIC for receiving a broadcast signal 410, selecting a segment 420 and selecting a portion 430.

In the foregoing description, the invention is described with reference to specific exemplary embodiments thereof. It will, however, be evident that various modifications and changes may be made thereto without departing from the broader spirit and scope of the present invention as set forth in the appended claims. The specification and drawings are to be regarded in an illustrative rather than a restrictive sense.

I claim:

1. A method comprising:
receiving a broadcast signal from a broadcast source;
selecting a broadcast segment of said broadcast signal;
determining if said broadcast segment contains a valid signal content for a signal database, wherein said signal database is a plurality of stored signals; and,
modifying said signal database with signal information from a portion of said broadcast segment if said broadcast segment contains a valid signal content.

2. The method of claim 1 wherein receiving a broadcast signal comprises receiving an audio signal.

3. The method of claim 1 wherein receiving a broadcast signal includes receiving an analog signal.

4. The method of claim 1 wherein receiving a broadcast signal comprises receiving a signal from a network connection.

5. The method of claim 1 wherein determining if said broadcast segment contains a valid signal content includes:
selecting a portion of said broadcast segment;
measuring at least one signal characteristic value of said portion; and,
comparing said signal characteristic value to a pre-determined threshold.

6. The method of claim 1 wherein determining if said broadcast segment contains a valid signal content includes:
generating a signal descriptor for a portion of the broadcast segment;
computing an equivalence value for said signal descriptor and a descriptor in a descriptor database; and,
comparing said equivalence value to a predetermined threshold.

7. The method of claim 1 wherein modifying said signal database includes adding a portion of said broadcast segment to said signal database.

8. The method of claim 1 wherein modifying said signal database includes updating at least one portion of a signal in the signal database with signal information from a portion of the broadcast segment.

9. The method of claim 3 wherein receiving an analog signal includes converting the analog signal to a digital signal.

10. The method of claim 6, wherein computing said equivalence value includes calculating a correlation coefficient.

11. The method of claim 6, wherein computing said equivalence value includes calculating a likeness coefficient.

12. The method of claim 6 wherein generating a signal descriptor includes selecting a portion of said broadcast segment as the signal descriptor.

13. The method of claim 6 wherein generating a signal descriptor includes:
selecting a portion of said broadcast segment;
measuring at least one signal characteristic of said portion; and,
selecting at least one signal characteristic as a signal descriptor.

14. The method of claim 8 wherein updating at least one portion of a signal in the signal database with signal information from a portion of said broadcast segment inlcudes:
averaging a portion of said broadcast segment with a portion of a signal in the signal database resulting in an average signal; and,
storing the average signal in the signal database.

15. The method of claim 13 wherein measuring at least one signal characteristic includes measuring a signal amplitude.

16. The method of claim 13 wherein measuring at least one signal characteristic includes measuring at least one signal frequency.

17. A machine readable storage medium having stored thereon instructions to be executed by a processor, the execution of said instructions to implement a method comprising:
receiving a broadcast signal from a broadcast source;
selecting a broadcast segment of said broadcast signal;
determining if said broadcast segment contains a valid signal content for a signal database, wherein said signal database is a plurality of stored signals; and,
modifying said signal database with signal information from a portion of said broadcast segment if said broadcast segment contains a valid signal content.

18. The medium of claim 17 wherein the execution of said instructions further cause the modifying of said signal database by adding a portion of the broadcast segment to said signal database.

19. The medium of claim 17 wherein the execution of said instructions further cause the modifying of said signal database by updating at least one portion of a signal in the signal database with signal information from a portion of the broadcast segment.

20. A system comprising:
a receiver to receive a broadcast signal;
a first memory coupled with said receiver to store a broadcast signal segment;
a processing device coupled with said first memory to process said broadcast signal, wherein processing comprises:
selecting a broadcast segment of said broadcast signal;
determining if said broadcast segment contains a valid signal content for a signal database, wherein a signal database is a plurality of stored signals; and
modifying said signal database with signal information from a portion of the selected broadcast segment if said broadcast segment contains a valid signal content;
a second memory coupled with said processor to store a signal database; and
a third memory coupled with said processor to store a descriptor database.

21. The system of claim 20 further comprising a fourth memory coupled with said processor to store an identification database, wherein said identification database contains information associated with a signal in the signal database and a descriptor in the descriptor database.

22. The system of claim 20 wherein the first, second, and third memory are in system memory.

23. The system of claim 20 wherein the first, second, and third memories are separate memory devices.

24. An apparatus comprising:
a receiver to receive a broadcast signal;
a selector to select a portion of said received broadcast signal;
an identifier to identify at least one signal characteristic of said portion;
a database to store signal information; and
a modifier to modify said database with signal information from said portion.

25. The apparatus of claim 24, wherein the identifier further includes a descriptor generator.

26. The apparatus of claim 24, wherein the receiver is a radio broadcast signal receiver.

27. An apparatus comprising:
a descriptor generator to generate descriptors of signals.

28. The apparatus of claim 27 further comprising a modifier to modify a signal database.

29. The apparatus of claim 27 further comprising an identifier to analyze signal characteristics.

30. The apparatus of claim 27 further comprising a selector to select a segment of a broadcast signal.
